(19) United States
(12) Patent Application Publication
(10) Pub. No.: US 2011/0080684 A1
(43) Pub. Date: Apr. 7, 2011

(54) Solid-state device for voltage decreasing for the electric circuit of direct and alternating current of medium and high voltage

(76) Inventors: Eduard Ulanovsky, Haifa (IL); Iurii Onufrienko, Charkov (UA); Alexander Ulanovsky, Andover, MA (US)

(21) Appl. No.: 12/589,074

(22) Filed: Oct. 15, 2009

(30) Foreign Application Priority Data
Oct. 28, 2008 (IL) 194955

(51) Int. Cl. H02H 1/00; H02H 9/00

(52) U.S. Cl. 361/127

(57) ABSTRACT

A solid-state device for decreasing voltage in medium- and high-voltage circuit comprises energy-dissipating element in the form of a non-linear resistance, mainly a power varistor, a contact system switched in parallel with this element and comprising at least a pair of power contacts, a gate blocking unit on semiconductors, a control block for a gate blocking unit and power contacts.

The varistor in chosen for voltage considerably lower than the voltage of electric circuit source, varistor capacity is a calculated for the time determined by operation conditions in this circuit, a pair (pairs) of power contacts and a gate blocking are chosen for operation with voltage drop which is formed at a varistor when load current is flowing through it.

### BACKGROUND OF THE INVENTION

The proposed invention relates to the field of electrical engineering and can be used as the means for voltage limitation in a.c. and d.c. circuits with medium- and high-voltage, as well as a specific device for decreasing voltage value.

Application of semi-conductor and non-linear resistors (varistors) together with power commutation and protective apparatuses is considered to be a progressive tendency in this field.

For example, a device by General Electric Co. “Thermally responsive metal oxide varistor transient suppression circuit” according to U.S. Pat. No. 4,068,281 from 1978 (US C1.361/106, 361/54, 338/20, 338/92; Int. C1.² HO2H5/04) comprises varistor 10 parallel to which a discharging circuit with a semiconductor switch is connected. With overvoltage acting for a long period of time, current flows through a varistor and after preset time of delay the said current is commuted into a discharge circuit due to short circuit (SHCRT) of a semiconductor switch. SHCRT is attained by means of thermistor 15 switching on a semiconductor switch depending on varistor temperature after delay time expiry.

Another device by company EXCEM (FR) “Circuit for protection against high amplitude electromagnetic impulses” according to patent FR 2716 307 from 1995 (Int.C1.⁶ HO2H3/22, 1/04, 7/26) comprises voltage limiter with spark spacer 2 (FIG. 2) and a discharge circuit with semiconductor switch 8 is connected to it in parallel. The value depending on the regime of spark spacer 2, namely voltage at this spacer, is measured by a control device 9 and serves for short-circuiting a semiconductor switch after delay time has been set.

Voltage limiter with several voltage limiting elements (varistors) is presented in the patent of company Dehn & Söhne GmbH (DE) DE 412 4321 from 1993 for “Over-load voltage protection circuit—has thermal fuse switch that responds if first varistor fails to establish second varistor path to ground”, Int.C1.⁵ HO2H9/04, 7/24; HO1C7/12; HO1H 37/76. In case one of the varistors is overloaded in the process of operation, then switching for the second voltage limiter (varistor) takes place. But as voltage limiter switched in is also quickly overloaded with prolonged overloading, this means that such a limiter doesn't fit operations with prolonged overloading.

The well-known electrical engineering company “ABB” (Germany) having a number of subsidiaries is pursuing highly active policy in the field of commutation devices with medium- and high-voltage and additional protection devices.

One of the most thoroughly developed apparatuses in this field is the solution according to patent ABB Shweiz AG (CH) for “Device for limiting short-time and long overvoltage” UA 76 524 from 2006-08-15, Int. C1. HO2H9/04.

Protection of this patent solution embraces other regions and countries,—see, e.g., application for European patent EP 1 304786, patent application US 2004 257 742, Russia patent RU 2282 294. This device for limiting short- and long-term overloads comprises varistor 1 and a discharge device switched in parallel to varistor. Discharge device comprises commutation element 4, e.g. a contactless switch calculated for long-time load current in electrical circuit wherein the device under study is included.

Switching in of the commuting element occurs with definite voltage in varistor 1. The latter is installed in first cell 24 and commuting element 4—in second cell 26. Cells 24 and 26 are positioned along symmetry axis 20 at a distance one from the other. Elements 5 for switching in and off commutating element are positioned in cell 28. Positioning of elements 1, 4 and 5 in separate cells permitted to develop a module-like structure of the limiter. Besides, elements 1 and 4 subjected to overvoltage action are separated one from the other, thus providing the ability of their independent cooling.

Thus, this device represents overvoltage limiter for network source with the possibility of using current flowing through varistor, magnetic field of this current, residual voltage on varistor and/or varistor temperature to be used as a working parameter in different variants.

Besides formal distinctions from the proposed device, the device presented by company ABB Shweiz AG and discussed above doesn't provide (because it does not set forth such a goal) for an aimed decrease in voltage and amplitude value of the expected short-circuit current in exploited and protected electric circuit.

Due to that, the last device discussed can be taken as the closest analogue to the proposed invention in relation to its schematic solution, as we couldn't find any “direct” analogue to the device proposed despite a number of other limiters using similar technical means found by us (the list of these devices can be submitted in case of necessity).

Taking into account all the above said, the aim of invention consists in creating a device for decreasing voltage (in particular on loading) in a.c. and d.c. electric circuits with medium- and high-voltages for operation under normal and emergency conditions.

### SUMMARY OF THE INVENTION

The goal set fort is attained by means of the proposed device for decreasing voltage comprising
energy-dissipating element in the form of a non-linear resistance, mainly a power varistor,
a contact system switched in parallel with this element and comprising at least a pair of power contacts,
a gate turn-off unit on semiconductors,
a control block for a gate turn-off unit and power contacts.

In the device power varistor is chosen for voltage considerably lower than the voltage of electric circuit source, at the same time power varistor capacity is calculated for operation with circuit current for the time determined by operation conditions in this circuit, and a pair (pairs) of power contacts and a gate turn-off unit are chosen for operation with voltage drop which is formed at power varistor when load current is flowing through it.

In this case, a gate turn-off unit is made of elements chosen from a group including a powerful gate turn-off thyristor, a powerful transistor, thyristor-condenser unit, bidirectional triode thyristor (triac).

In relation to medium- and high-voltage circuits a calculated number “n” of such devices with the same insulation strengthened relative to Earth is used, and when “n”≧2, these devices are connected electrically in series.

In relation to multiphase (m-phase) a.c. circuit, “n” number of such devices with the same insulation strengthened relative to Earth are included into each phase.

In relation to medium- and high-voltage circuits, a calculated “n” number of such devices with the same insulation strengthened relative to Earth (with “n”≧2 these devices are connected electrically in series) is used in each phase.

### BRIEF DESCRIPTION OF THE DRAWINGS

The essence of the proposed technical solution is explained in the drawings attached where showed

on FIG. 1—is a scheme of the known approach (prior art)—introduction of additional non-linear resistance into electric circuit,

FIG. 2—is a scheme illustrating the principle of voltage decrease in electric circuit by means of the proposed device,

FIG. 3—is a basic variant of the proposed device with a gate turn-off unit and a control block,

FIG. 4—is a variant of the device with serial switching in of separate devices for voltage decrease.

### DESCRIPTION OF THE PREFERRED EMBODIMENT

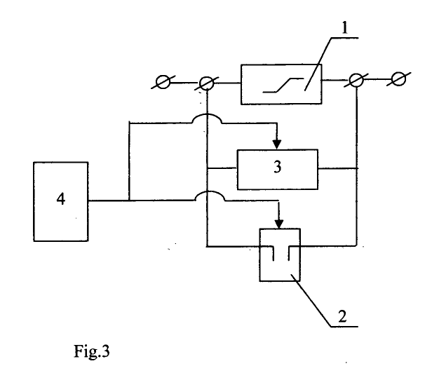

The proposed solid-state (semiconductor) device for decreasing d.c. and a.c. current voltage in its basic variant (FIG. 3) comprises
energy-dissipating element in the form of a non-linear resistance, mainly power varistor 1,
a contact system switched in parallel with this element and comprising at least a pair of power contacts 2,
gate turn-off unit 3 on semiconductors,
control block 4 for gate turn-off unit 3 and power contacts 2.

In the device power varistor is chosen for voltage considerably lower than the voltage of electric circuit source, at the same time power varistor capacity is calculated for operation with circuit current for the time determined by operation conditions in this circuit, and a pair (pairs) of power contacts and a gate turn-off unit are chosen for operation with voltage drop which is formed at power varistor when load current is flowing through it.

In this case, a gate turn-off unit is made of elements chosen from a group including a powerful gate turn-off thyristor, a powerful transistor, thyristor-condenser unit, bidirectional triode thyristor (triac).

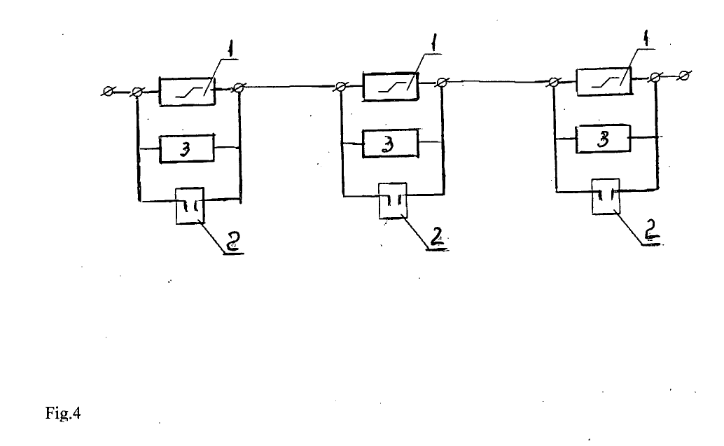

In relation to medium- and high-voltage circuits a calculated number “n” of such devices with the same insulation strengthened relative to Earth is used in each phase, and with “n”≧2 these devices are connected electrically in series, for example, as it is shown in FIG. 4.

Operation of the proposed device for voltage decrease (further VDD) is based on introduction of a non-linear resistance (FIG. 1) with higher non-linearity coefficient (such a resistance is called “varistor” in electrical engineering) into electric circuit for the time determined by the conditions of this circuit scheme operation.

With circuit current (practically load current) flowing through power varistor 1, voltage drop ΔU occurs in it which is subtracted from the source voltage Uₛ (power supply) resulting in load Z having voltage U_{z}=Uₛ-ΔU, thus meaning voltage decrease in the circuit for value ΔU.

Application of varistor/varistors (especially oxide-zinc ones) as non-linear resistance is determined by the fact that they possess practically constant value of voltage drop which is little varying even with great changes in current flowing through them, i.e. ΔU≈Const.

An important feature of VDD is the fact that varistors are chosen in such a way that voltage drop on them (ΔU) is less than voltage at the source Uₛ, i.e. ΔU<Uₛ.

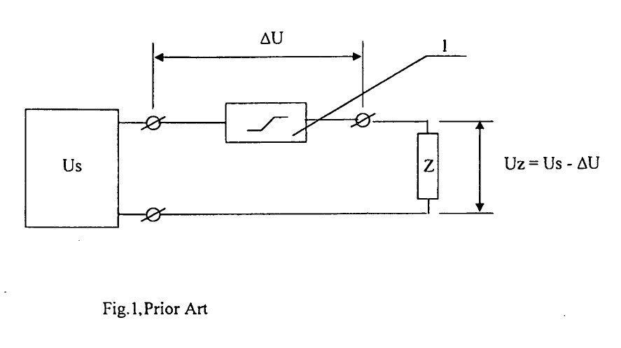

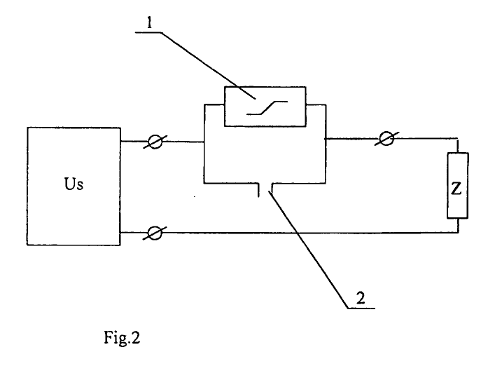

In case ΔU is higher or equal to Uₛ (Uₛ≦ΔU), then circuit voltage at introduction of varistors into the circuit is equal to “O” and VDD is to be turned into a switch what from VDD is not required (it isn't its function). For varistors introduction into the circuit VDD should be fitted with contact system 2 as is shown at the VDD scheme (FIGS. 2 and 3).

In closed position of contact system 2 varistor 1 is by-passed and doesn't act on circuit voltage. Correspondingly, voltage on load is practically equal to source voltage, i.e. U_{z}=Uₛ.

In opened position of contact system 2 load current goes through varistor creating voltage drop ΔU which is subtracted from the source voltage, i.e. U_{z}=Uₛ−ΔU as has been mentioned earlier.

For providing practically arcless breaking of contact system (power contacts) 2, the latter is by-passed by gate turn-off unit 3 made (as has been mentioned earlier) of elements chosen from their group including powerful gate turn-off thyristor (GTO), powerful transistor (iGBT), thyristor-condenser unit, triac.

VDD is functioning in the following way:

With prolonged regime of operation when there is no necessity in decreasing circuit voltage, control block 4 (FIG. 3) switches on (closes) contact system 2 and circuit current passes VDD practically without voltage decrease.

With the necessity of voltage decrease in the circuit, control block 4 opens gate turn-off unit 3 for current passage and breaks contact system 2. Due to that circuit current moves from contact system 2 into unit 3. In this case, due to the fact that direct voltage drop in unit 3 is usually lower that voltage necessary for arc occurrence in inter-contact spacing, practically arcless breaking of contacts in contact system 2 occurs.

In this case control block 4 turns off unit 3, due to which circuit current is transferred from unit 3 to power varistor 1. This leads to voltage drop ΔU at VDD outputs thus decreasing voltage in the circuit for value ΔU.

It is necessary to mention an important feature of VDD (FIG. 3): voltage applied to contact system 2 during operation as well as that applied to semiconductor (in the general case solid-state) gate turn-off unit 3 and for which unit elements are to be calculated is determined only by voltage drop ΔU in power varistor 1 and is independent of voltage in the source Uₛ.

This feature permits, in case of necessity, to decrease voltage in medium- and high-voltage circuits for value ΔUhv being higher than value ΔU created by a separate VDD, to connect in series as many VDD with the same insulation strengthened relative to Earth as necessary for obtaining the required value ΔUhv=ΔU*n (where “n” is the number of separate VDDs).

With industrial production of VDD, this feature permits to limit the number of VDD sizes in relation to voltage, thus making the production cheaper.

In relation to medium- and high-voltage circuits a calculated number of “n” separate devices with similar insulation strengthened relative to Earth is used, and with “n”≧2 these devices are connected electrically in series.

In relation to multiphase (m-phase) a.c. circuit, “n” number of such devices with the same insulation strengthened relative to Earth is included into each phase.

In relation to medium- and high-voltage circuits, each phase uses a calculated number “n” of such devices with the same insulation strengthened relative to Earth (with “n”≧2 these devices are connected electrically in series).

I claim:

1. A solid-state device for decreasing voltage in medium- and high-voltage circuit comprising
energy-dissipating element in the form of a non-linear resistance, mainly a power varistor,
a contact system switched in parallel with this element and comprising at least a pair of power contacts,
a gate turn-off unit on semiconductors,
a control block for a gate turn-off unit and power contacts,
hereby power varistor is chosen for voltage considerably lower than the voltage of electric circuit source, power varistor capacity is calculated for operation with circuit current for the time determined by operation conditions in this circuit, and a pair/pairs of power contacts and a gate turn-off unit are chosen for operation with voltage drop which is formed at power varistor when load current is flowing through it.

2. The device according to claim 1, wherein a gate turn-off unit is made of elements chosen from a group including a powerful gate turn-off thyristor, a powerful transistor, thyristor-condenser unit, bidirectional triode thyristor (triac).

3. The device according to claim 1, wherein in relation to medium- and high-voltage circuits a calculated number of such devices with the same insulation strengthened relative to Earth is used being connected electrically in series.

4. The device according to claim 1 or 2, wherein in relation to multiphase a.c. circuit, “m” number of such devices is used being included into each phase,
where m—is the number of phases.

5. The device according to claim 4, wherein in relation to medium- and high-voltage circuits, a calculated “n” number of such separate devices with the same insulation strengthened relative to Earth and with “n”≧2 separate devices connected electrically in series is used in each phase.
